(19) United States
(12) Patent Application Publication
(10) Pub. No.: US 2017/0173668 A1
(43) Pub. Date: Jun. 22, 2017

(54) REFRACTORY SLURRY OF REDUCING CARBON PICKUP IN LOST FOAM CASTING, FOAM PATTERN AND PROCESSES FOR MANUFACTURING AND USING THE SAME

(71) Applicant: General Electric Company, Schenectady, NY (US)

(72) Inventors: Zhaoping Wu, Shanghai (CN); Brian Victor Moore, Niskayuna, NY (US); Michael Douglas Arnett, Simpsonville, SC (US); Dejia Wang, Shanghai (CN); Junyoung Park, Greer, SC (US); Yanfei Gu, Shanghai (CN); Qi Zhao, Niskayuna, NY (US)

(73) Assignee: General Electric Company, Schenectady, NY (US)

(21) Appl. No.: 15/442,806

(22) Filed: Feb. 27, 2017

Related U.S. Application Data
(62) Division of application No. 14/223,573, filed on Mar. 24, 2014, now abandoned.

(51) Int. Cl. B22C 7/02; B01J 23/00; B01J 23/10; B22C 3/00; B22C 9/04

(52) U.S. Cl. CPC B22C 7/023; B22C 3/00; B22C 9/046; B01J 23/10; B01J 23/002

(57) ABSTRACT

Refractory slurry for use in coating a foam cluster to provide a foam pattern for lost foam casting is provided. The slurry includes a catalyst capable of catalyzing reactions for vaporizing the foam cluster. A foam pattern with a refractory coating including the catalyst and processes for preparing the foam pattern and using the foam pattern are also provided.

### CROSS-REFERENCE TO RELATED APPLICATION

The present application is a divisional of, and claims priority to, U.S. patent application Ser. No. 14/223,573, filed on Mar. 24, 2014, which further claims priority to C.N. Patent Application Ser. No. 201310098984.7 filed on Mar. 26, 2013, the disclosure of both are incorporated herein by reference.

### FIELD OF THE INVENTION

Embodiments of the present invention relate to lost-foam casting, and, more particularly, to a foam pattern for lost foam casting.

### BACKGROUND

Lost-foam casting involves preparing a pattern that includes a plastic (e.g., polystyrene foam) cluster of the desired cast part and a refractory coating on the plastic cluster, and then pouring molten metal to vaporize and displace the plastic cluster. The molten metal reproduces the plastic cluster to provide a casting.

Typically, in a lost-foam casting process, a plastic cluster in the shape of the desired cast part is prepared and then coated with a refractory coating to form a pattern. The pattern is embedded in dry sand, which is compacted by mechanical means such as vibration, so as to provide a mold about the pattern. The refractory coating applied on the plastic cluster, which at the same time constitutes the pattern surface can be responsible for the casting surface quality and preventing molten metal penetration into the dry sand. Then molten metal is poured into the mold to vaporize the plastic cluster under a vacuum environment. The plastic cluster within the refractory coating is decomposed by the molten metal, which replaces the plastic cluster and thereby precisely duplicates all of the features of the cluster. After being cooled down, a casting that exactly replicates the shape of the plastic cluster is formed. By removing the sand as well as the refractory coating around the casting, the desired cast part is obtained.

Lost-foam casting is a smart casting process and it has many advantages in comparison with conventional sand casting processes. For examples, as a cavity-less casting process without need of parting, lost-foam casting is able to make various complicated castings that is difficult to be manufactured by traditional casting techniques. Moreover, since the dry sand used in the lost-foam casting can be reused, not only the industry wastes can be reduced, but also the cost can be decreased.

However, there is a problem with lost-foam casting. It tends to produce carbon pickup or carbon residues on cast parts, because the plastic cluster generates carbon when it is volatilized and the carbon is absorbed into the liquid metal thereby raising the carbon level of the finished stainless steel product. The carbon formed from the plastic cluster and dissolving in the metal may degrade the properties of the cast part. Thus, how to minimize carbon residues is a persistent challenge to lost-foam casting. For example, it has been developed to prevent the carbon pickup issue by choosing a foam material with a relatively lower carbon content or density to make the cluster, or introducing additional vacuum to the casting flask to aid in the removal of the carbon residues. But these approaches do not fully resolve the carbon pickup problem. For example, lost-foam casting still has difficulty in casting stainless steel, especially low carbon stainless steel, which is sensitive to the carbon pickup problem.

Therefore, it is desired to provide a novel method to solve the carbon pickup issue in lost-foam casting, especially for low carbon stainless steel casting.

### BRIEF DESCRIPTION

In one aspect, the present disclosure relates to a foam pattern for lost foam casting. The foam pattern comprises a foam cluster and a refractory coating coated on the foam cluster. The refractory coating comprises a catalyst capable of catalyzing reactions for vaporizing the foam cluster. The catalyst comprises at least a carnegieite-like material of formula (Na₂O)ₓNa₂[Al₂Si₂O₈] or a perovskite material of formula AₐB_{b}C_{c}D_{d}O_{3-δ}, wherein 0<x≦1, 0<a<1.2, 0≦b≦1.2, 0.9<a+b≦1.2, 0<c<1.2, 0≦d≦1.2, 0.9<c+d≦1.2, −0.5<δ0.5<; A is selected from calcium (Ca), strontium (Sr), barium (Ba), and any combination thereof; B is selected from lithium (Li), sodium (Na), potassium (K), rubidium (Rb) and any combination thereof; C is selected from cerium (Ce), zirconium (Zr), antimony(Sb), praseodymium (Pr), titanium (Ti), chromium (Cr), manganese (Mn), ferrum (Fe), cobalt (Co), nickel (Ni), gallium(Ga), tin (Sn), terbium (Tb) and any combination thereof; and D is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), ebium (Er), thulium (Tm), ytterbium (Yb), lutetium (Lu), scandium (Sc), titanium (Ti), vanadium (V), chromium (Cr), manganese (Mn), ferrum (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), gallium (Ga), indium (In), tin (Sn), antimony (Sb) and any combination thereof.

In another aspect, the present disclosure relates to a process for making a foam pattern for lost foam casting. The process comprises steps of: preparing a foam cluster, and coating the foam cluster with a refractory coating comprising a catalyst capable of catalyzing reactions for vaporizing the foam cluster. The catalyst comprises at least a carnegieite-like material of formula (Na₂O)ₓNa₂[Al₂Si₂O₈] or a perovskite material of formula AₐB_{b}C_{c}D_{d}O_{3-δ}, wherein 0<x≦1, 0<a<1.2, 0≦b≦1.2, 0.9<a+b≦1.2, 0<c<1.2, 0.9<c+d≦1.2, −0.5<δ<0.5; A is selected from calcium (Ca), strontium (Sr), barium (Ba), and any combination thereof B is selected from lithium (Li), sodium (Na), potassium (K), rubidium (Rb) and any combination thereof; C is selected from cerium (Ce), zirconium (Zr), antimony(Sb), praseodymium (Pr), titanium (Ti), chromium (Cr), manganese (Mn), ferrum (Fe), cobalt (Co), nickel (Ni), gallium(Ga), tin (Sn), terbium (Tb) and any combination thereof and D is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), ebium (Er), thulium (Tm), ytterbium (Yb), lutetium (Lu), scandium (Sc), titanium (Ti), vanadium (V), chromium (Cr), manganese (Mn), ferrum (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), gallium (Ga), indium (In), tin (Sn), antimony (Sb) and any combination thereof.

In yet another aspect, the present disclosure relates to refractory slurry for use in coating a foam cluster to provide a foam pattern for lost foam casting. The refractory slurry comprises a catalyst capable of catalyzing reactions for vaporizing the foam cluster. The catalyst comprises at least a carnegieite-like material of formula (Na₂O)ₓNa₂[Al₂Si₂O₈] or a perovskite material of formula AₐB_{b}C_{c}D_{d}O_{3-δ}, wherein 0<x≦1, 0<a<1.2, 0≦b≦1.2, 0.9<a+b≦1.2, 0<c<1.2, 0≦d≦1.2, 0.9<c+d≦1.2, −0.5<δ<0.5; A is selected from calcium (Ca), strontium (Sr), barium (Ba), and any combination thereof; B is selected from lithium (Li), sodium (Na), potassium (K), rubidium (Rb) and any combination thereof; C is selected from cerium (Ce), zirconium (Zr), antimony(Sb), praseodymium (Pr), titanium (Ti), chromium (Cr), manganese (Mn), ferrum (Fe), cobalt (Co), nickel (Ni), gallium(Ga), tin (Sn), terbium (Tb) and any combination thereof; and D is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), ebium (Er), thulium (Tm), ytterbium (Yb), lutetium (Lu), scandium (Sc), titanium (Ti), vanadium (V), chromium (Cr), manganese (Mn), ferrum (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), gallium (Ga), indium (In), tin (Sn), antimony (Sb) and any combination thereof.

In yet another aspect, the present disclosure also relates to a lost foam casting method. The method comprises steps of: providing a foam pattern comprising a foam cluster and a refractory coating coated on the foam cluster, wherein the refractory coating comprises a catalyst capable of catalyzing reactions for vaporizing the foam cluster, which comprises at least a carnegieite-like material of formula (Na₂O)ₓNa₂[Al₂Si₂O₈ or a perovskite material of formula AₐB_{b}C_{c}D_{d}O_{3-δ}; placing the pattern in a bed of sand to form a mold about the foam pattern; introducing molten metal into the mold to vaporize and displace the foam cluster of foam pattern, and form a casting that replicates the shape of the foam pattern; catalyzing the reactions for vaporizing the foam cluster around the refractory coating; and removing the sand from around the casting, wherein 0<x≦1, 0<a<1.2, 0≦b≦1.2, 0.9<a+b≦1.2, 0<c<1.2, 0≦d≦1.2, 0.9<c+d≦1.2, −0.5<δ<0.5; A is selected from calcium (Ca), strontium (Sr), barium (Ba), and any combination thereof; B is selected from lithium (Li), sodium (Na), potassium (K), rubidium (Rb) and any combination thereof C is selected from cerium (Ce), zirconium (Zr), antimony(Sb), praseodymium (Pr), titanium (Ti), chromium (Cr), manganese (Mn), ferrum (Fe), cobalt (Co), nickel (Ni), gallium(Ga), tin (Sn), terbium (Tb) and any combination thereof; and D is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), ebium (Er), thulium (Tm), ytterbium (Yb), lutetium (Lu), scandium (Sc), titanium (Ti), vanadium (V), chromium (Cr), manganese (Mn), ferrum (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), gallium (Ga), indium (In), tin (Sn), antimony (Sb) and any combination thereof.

### BRIEF DESCRIPTION OF THE DRAWINGS

The above and other aspects, features, and advantages of the present disclosure will become more apparent in light of the subsequent detailed description when taken in conjunction with the accompanying drawing in which:

FIG. 1 is a schematic view showing catalytic gasification mechanism of a foam cluster during lost-foam casting.

### DETAILED DESCRIPTION

Approximating language, as used herein throughout the specification and claims, may be applied to modify any quantitative representation that could permissibly vary without resulting in a change in the basic function to which it is related. Accordingly, a value modified by a term or terms, such as “about,” is not to be limited to the precise value specified. In certain embodiments, the term “about” means plus or minus ten percent (10%) of a value. For example, “about 100” would refer to any number between 90 and 110. Additionally, when using an expression of “about a first value-a second value,” the about is intended to modify both values. In some instances, the approximating language may correspond to the precision of an instrument for measuring the value or values.

Any numerical values recited herein include all values from the lower value to the upper value in increments of one unit provided that there is a separation of at least 2 units between any lower value and any higher value. As an example, if it is stated that the dosage of a component or a value of a process variable such as, for example, temperature, pressure, time and the like is, for example, from 1 to 90, more particularly from 20 to 80, more particularly from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless defined otherwise, technical and scientific terms used herein have the same meaning as is commonly understood by one of skill in the art to which this invention belongs. The terms “first,” “second,” and the like, as used herein do not denote any order, quantity, or importance, but rather are used to distinguish one element from another. Also, the terms “a” and “an” do not denote a limitation of quantity, but rather denote the presence of at least one of the referenced items.

In embodiments of the present invention, a foam pattern for lost-foam casting is provided. The foam pattern has a foam cluster coated with a refractory coating, which can provide a protective barrier between the molten metal and the sand mold around the foam pattern during the lost foam casting process, and ensure the integrity of the as cast surface. The refractory coating includes a catalyst capable of catalyzing reactions for vaporizing the foam cluster. As used herein, a catalyst is a material that causes or accelerates a chemical reaction, in this case vaporizing the foam cluster. Vaporizing refers to a chemical or physical change resulting in the production of a vapor or gas. A such vaporizing, which may also be referred to as gasifying, and refers to the reaction involving the lost foam casting, for example, reactions for converting the foam with oxygen (O₂) and/or water (H₂O) to gases such as carbon dioxide (CO₂), carbon monoxide (CO) and hydrogen (H₂). As the catalyst itself may be resistant to the temperature of the molten metal poured into the foam pattern during the lost foam casting process, the catalyst in this case may have a dual role, acting not just to catalyze the reaction but also as the refractory compound. As such the catalyst may constitute the majority of the refractory coating where the catalyst also acts as the refractory compound.

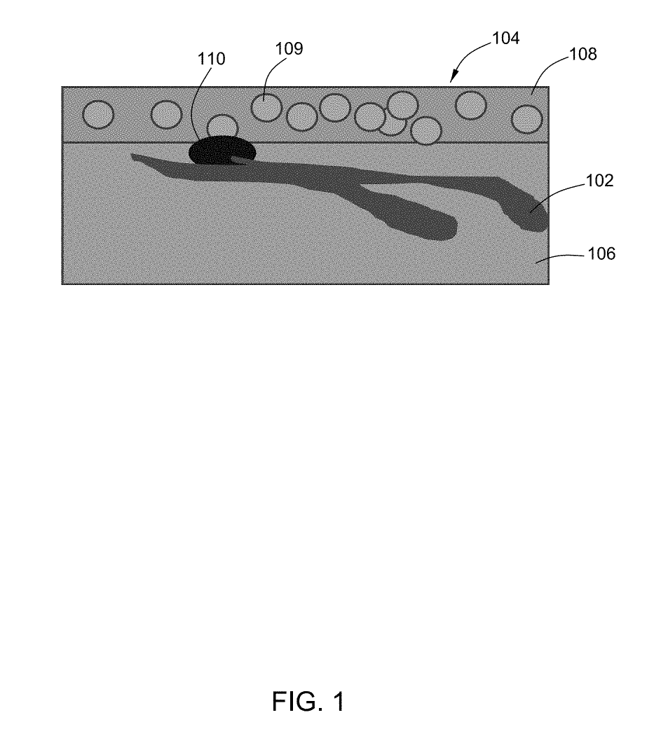

The gasification mechanism during lost-foam casting is illustrated in FIG. 1. When molten metal 102 is poured into a foam pattern 104 including a foam cluster 106 coated with a refractory coating 108, the foam cluster 106 is caused to be vaporized by the high temperature molten metal 102, during which the carbon in the foam reacts with O₂ and/or H₂ O in the air of the foam to give birth to gases 109 including but not limited to CO₂, CO, and H₂. These gases 109 escape through the refractory coating 108. The molten metal 102 replaces the vaporized foam cluster 106 to form a casting within the refractory coating 108. Carbon residues 110 may be formed in the casting, causing carbon pickup issue once the casting is cooled down to form the cast part. Results of experiments and application show that the carbon pickup tends to occur at the surface of the cast part of lost-foam casting and at where is adjacent to the pouring gate. The formation of carbon residues 110 or carbon pickup is either due to the lack of time to vaporize (not fully react with oxygen) or due to quick quenching the surface temperature and having not enough reaction thermal dynamics assuming that there is enough oxygen or air.

The catalyst contained in the refractory coating 108 can help or accelerate the reactions for vaporizing the foam cluster. The carbon in the foam can be vaporized at much higher efficiency and/or at lower temperature than that without catalyst in the refractory coating, especially where is adjacent to the refractory coating 108, and thus the formation of carbon residues may be minimized. In particular, even if carbon residues are formed, the catalyst in the refractory coating is also able to further gasify the carbon residues that move to the surface of the casting. Therefore, the foam pattern coated with the catalyst is capable of minimizing the formation of carbon residues and preventing the carbon pickup on the cast part, and suitable for making casts of stainless steel, especially low carbon stainless steel by lost-foam casting.

The catalyst may be an anti-coking material. In some embodiments, the catalyst comprises at least a carnegieite-like material of formula I or a perovskite material of formula II:

(Na₂O)ₓNa₂[Al₂Si₂O₈] (I),

AₐB_{b}C_{c}D_{d}O_{3-δ} (II),

wherein 0<x≦1, 0<a<1.2, 0≦b≦1.2, 0.9<a+b≦1.2, 0<c<1.2, 0.9<c+d≦1.2, −0.5<δ<0.5;
A is selected from calcium (Ca), strontium (Sr), barium (Ba), and any combination thereof;
B is selected from lithium (Li), sodium (Na), potassium (K), rubidium (Rb), and any combination thereof;
C is selected from cerium (Ce), zirconium (Zr), antimony (Sb), praseodymium (Pr), titanium (Ti), chromium (Cr), manganese (Mn), ferrum (Fe), cobalt (Co), nickel (Ni), gallium (Ga), tin (Sn), terbium (Tb) and any combination thereof; and
D is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), titanium (Ti), vanadium (V), chromium (Cr), manganese (Mn), ferrum (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), gallium (Ga), indium (In), tin (Sn), antimony (Sb) and any combination thereof.

In some specific embodiments, the perovskite material is selected from the group consisting of doped LaCrO₃, doped LaMnO₃, BaCeO₃, BaZrO₃, BaCe_{y}Zr_{(1-y)}O₃, BaCe_{y}Y_{(1-y)}O₃ and combinations thereof, wherein 0≦y≦1. In particular, the perovskite material is BaCe_{y}Zr_{(1-y)}O₃, wherein 0≦y≦1, for example, BaCe_{0.7}Zr_{0.3}O₃.

The carnegieite-like material of formula I is proved to have the capability of catalyzing reactions for converting carbon into carbon oxide and is described more fully in U.S. patent application U.S. 2011/0319690 entitled “method for converting carbon and hydrocarbon cracking and apparatus for hydrocarbon cracking”, filed on May 5, 2011, which is herein incorporated by reference in its entirety. The perovskite material of formula II is proved to have the decoking capability for gasifying carbon and is described in U.S. patent application U.S. 2011/0295051 entitled “method and reactor for cracking hydrocarbon”, filed on May 25, 2011 and a PCT patent application WO 2012/087550 entitled “method and reactor for cracking hydrocarbon and method for coating the reactor”, filed on Dec. 5, 2011, which are herein incorporated by reference in their entirety.

The foam cluster may be made from any foam material usable in the preparation of molded foam articles used in the lost-foam casting. Examples of suitable foam materials include expanded polystyrene (EPS), styrene-methyl methacrylate (STMMA), and expanded polystyrene-methyl methacrylate (EPSMMA).

In some embodiments, the catalyst itself may have a dual role, acting not just to catalyze the reaction but also as the refractory compound. As such the refractory coating may comprise about 1-80% by weight of the catalyst of Formula I or II. In certain embodiments, the catalyst constitutes the majority, about 50-80%, by weight of the refractory coating. For example, the carnegieite-like material of formula I is resistant to a temperature up to about 1000° C., and thus it may constitute the majority of the refractory coating, as both the refractory compound and catalyst, when the highest temperature during the lost foam casting is below 1000° C. The perovskite material of formula II is resistant to a temperature up to about 1800° C., and thus it may constitute the majority of the refractory coating, as both the refractory compound and catalyst, when the highest temperature during the lost foam casting is below 1800° C. In some embodiments, the refractory coating comprise about 1-30% by weight of the catalyst and about 30-60% by weight of a refractory compound different from the catalyst. The refractory compound may be any material that is refractory and resistant to the temperature of the molten metal poured into the foam pattern during the lost foam casting process. Non-limiting examples of the refractory compound include alumina, zirconia, silica, chromite, alumina-silicates, and combinations thereof.

Besides the catalyst and the refractory compound, the refractory coating of the foam pattern may further comprise a binder, a surfactant, a thixotropic agent and a dispersant. The binder may comprise an inorganic binder and an organic binder. In a specific embodiment, the inorganic binder comprises clay. In a specific embodiment, the organic binder comprises carboxymethyl cellulose (CMC) gum. The binder comprising clay and CMC gum can not only provide sufficient binding strength for forming the refractory coating, but also enable the refractory coating to be easily removed after the as cast part is formed.

Embodiments of the present invention also provide a process of making a foam pattern for lost-foam casting. Firstly a foam cluster is prepared, and then the foam cluster is coated with a refractory coating comprising a catalyst capable of catalyzing reactions for vaporizing the foam cluster. The foam cluster may be prepared by various ways, including but not limited to foam molding. The refractory coating may be coated onto the foam cluster via dipping, brushing, spraying, flow coating or their combinations.

In some embodiments, the refractory coating is coated onto the foam cluster by a process comprising steps: preparing refractory slurry containing the catalyst, applying the slurry to the foam cluster to form a slurry coating on the foam cluster; and drying the slurry coating. In some specific embodiments, the refractory coating is achieved by dipping the foam cluster into the refractory slurry and then drying the foam cluster applied with the refractory slurry. For example, the refractory coating may be achieved by dipping the foam cluster into the refractory slurry and then left to drip dry for up to about 24 hours under about 80° C., and more particularly in a controlled room temperature.

Embodiments of the present invention also relates to the refractory slurry for use in coating a foam cluster to provide a foam pattern for lost foam casting. The refractory slurry comprises a catalyst capable of catalyzing reactions for vaporizing the foam cluster, as described above. The refractory slurry may comprise about 1-80% by weight of the catalyst. In some embodiments, the catalyst itself functions as the refractory compound and constitutes about 50-80% by weight of the refractory slurry. In some embodiments, the refractory slurry comprises about 1-30% by weight of the catalyst and about 30-60% by weight of a refractory compound selected from the group consisting of alumina, zirconia, silica, chromite, alumina-silicates, and combinations thereof. Besides the catalyst and the refractory compound, the refractory slurry may further comprise other materials used to help forming the slurry and/or constituting the refractory coating, including but not limited to binders, suspending media such as water, surfactants, thixotropic agents, dispersants, and biocides. For example, in some embodiments, the refractory slurry may further comprise a binder, a surfactant, a thixotropic agent and a dispersant. The binder may comprise clay and CMC gum. The refractory slurry may be prepared by mixing powder of the catalyst, particles of a refractory compound, and the materials used to help forming the slurry and/or constituting the refractory coating, as described above.

Embodiments of the present invention also provide a lost foam casting method using the foam pattern having a foam cluster coated with a refractory coating including a catalyst capable of catalyzing reactions for vaporizing the foam cluster. After the foam pattern is finished, it is placed into a bed of sand to form a mold. Molten metal is poured into the mold to vaporize and displace the foam cluster of foam pattern, and form a casting that replicates the shape of the foam pattern, during which the catalyst in the refractory coating catalyzes the reactions for vaporizing the foam cluster. After the casting is cooled, and the sand and the refractory coating around the casting are successively or together removed, the desired cast part is obtained.

### EXAMPLE

A foam cluster may be made from EPS by a foam molding process. Refractory slurry containing a catalyst capable of catalyzing reactions for vaporizing the foam cluster (BaCe_{0.7}Zr_{0.3}O₃ powder in this example) may be prepared by mixing the materials listed in the following table:

| Items | wt % |
|---|---|
| water | 31.49 |
| CMC gum | 0.04 |
| clay (rheology modifier) | 0.33 |
| Surfynol 104PA (wetting and foam control) | 0.23 |
| dispersant (e.g., Darvan 811) | 0.40 |
| sodium Lignosulphonate (dispersant) | 0.26 |
| defoamer | 0.13 |
| alumina | 47.63 |
| dye (blue) | 0.02 |
| vinyl acetate/enthylene | 2.71 |
| biocide (e.g., veriguard) | 0.07 |
| Aerosol 75% surfactant | 0.02 |
| BaCe_{0.7}Zr_{0.3}O₃ (catalyst) | 16.67 |

The foam cluster may be dipped into the refractory slurry to make it coated with a layer of the slurry, and then the foam cluster coated with the slurry may be left to drip dry in a controlled room temperature. Coating thickness may be controlled at about 0.1-1.0 mm by optimizing the slurry preparation and dipping process. Such that a foam pattern with a refractory coating including BaCe_{0.7}Zr_{0.3}O₃ particles can be obtained. BaCe_{0.7}Zr_{0.3}O₃ is capable of catalyzing reactions for vaporizing the foam cluster and therefore can effectively reduce carbon residual on the surface of the casting formed in the refractory coating of the foam pattern. When the foam pattern is used in lost foam casting, the carbon pickup on the cast part should be minimized.

The invention may be embodied in other specific forms without departing from the spirit or essential characteristics thereof. The foregoing embodiments are therefore to be considered in all respects as illustrative rather than limiting on the invention described herein. The scope of embodiments of the invention is thus indicated by the appended claims rather than by the foregoing description, and all changes that come within the meaning and range of equivalency of the claims are therefore intended to be embraced therein.

What is claimed is:

1. A lost foam casting method, comprising:
providing a foam pattern comprising a foam cluster and a refractory coating coated on the foam cluster, wherein the refractory coating comprises a foam cluster vaporizing catalyst, the foam cluster vaporizing catalyst comprising at least a carnegieite-like material of formula (Na₂O)ₓNa₂[Al₂Si₂O₈] or a perovskite material of formula AₐB_{b}C_{c}D_{d}O_{3-δ}, wherein:
0<x≦1, 0<a<1.2, 0≦b≦1.2, 0.9<a+b≦1.2, 0<c<1.2, 0≦d≦1.2, 0.9<c+d≦1.2, −0.5<δ<0.5;
A is selected from calcium (Ca), strontium (Sr), barium (Ba), and any combination thereof;
B is selected from lithium (Li), sodium (Na), potassium (K), rubidium (Rb) and any combination thereof;
C is selected from cerium (Ce), zirconium (Zr), antimony(Sb), praseodymium (Pr), titanium (Ti), chromium (Cr), manganese (Mn), ferrum (Fe), cobalt (Co), nickel (Ni), gallium(Ga), tin (Sn), terbium (Tb) and any combination thereof; and
D is selected from lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), ebium (Er), thulium (Tm), ytterbium (Yb), lutetium (Lu), scandium (Sc), titanium (Ti), vanadium (V), chromium (Cr), manganese (Mn), ferrum (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), gallium (Ga), indium (In), tin (Sn), antimony (Sb) and any combination thereof;
placing the pattern in a bed of sand to form a mold about the foam pattern;
introducing molten metal into the mold to vaporize and displace the foam cluster of foam pattern and form a casting that replicates the shape of the foam pattern, while catalyzing the reactions for vaporizing the foam cluster around the refractory coating; and
removing the sand from around the casting.

2. The method of claim 1, further comprising removing the refractory coating from around the casting.

3. The method of claim 1, further comprising coating the refractory coating on the foam cluster by a process comprising the following steps:
preparing a refractory slurry containing the foam cluster vaporizing catalyst;
applying the refractory slurry to the foam cluster to form a slurry coating on the foam cluster; and
drying the slurry coating.

4. The method of claim 1, wherein the perovskite material is selected from the group consisting of doped LaCrO₃, doped LaMnO₃, BaCeO₃, BaZrO₃, BaCe_{y}Zr_{(1-y)}O₃, BaCe_{y}Y_{(1-y)}O₃ and combinations thereof, wherein 0≦y≦1.

5. The method of claim 4, wherein the perovskite material is BaCe_{y}Zr_{(1-y)}O₃, wherein 0≦y≦1.

6. The method of claim 1, wherein the catalyst is about 1-80% by weight of the refractory coating.

7. The method of claim 6, wherein the catalyst is about 50-80% by weight of the refractory coating.

8. The method of claim 6, wherein the catalyst is about 1-30% by weight of the refractory coating.

9. The method of claim 8, wherein the refractory slurry further comprises a refractory compound, wherein the refractory compound is about 30-60% by weight of the refractory slurry and is selected from the group consisting of alumina, zirconia, silica, chromite, alumina-silicates, and combinations thereof.

10. The method of claim 7, wherein the refractory coating further comprises a binder, a surfactant, a thixotropic agent and a dispersant.

11. The method of claim 10, wherein the binder comprises clay and carboxymethyl cellulose (CMC) gum.
